(19) United States
(12) Patent Application Publication
(10) Pub. No.: US 2023/0386364 A1
(43) Pub. Date: Nov. 30, 2023

(54) DIAPHRAGM EFFORT SIMULATOR

(71) Applicant: Covidien LP, Mansfield, MA (US)

(72) Inventors: Jaroslaw A. Traczyk, Warsaw (PL); Camille Ann Johnson, San Diego, CA (US); Cynthia A. Miller, Laguna Hills, CA (US); Gary S. Milne, Louisville, CO (US)

(73) Assignee: Covidien LP, Mansfield, MA (US)

(21) Appl. No.: 18/323,858

(22) Filed: May 25, 2023

Related U.S. Application Data
(60) Provisional application No. 63/346,492, filed on May 27, 2022.

(51) Int. Cl. G09B 23/28

(52) U.S. Cl. CPC G09B 23/288

(57) ABSTRACT

Systems and methods for a diaphragm effort simulator are disclosed. For example, the technology relates to a system for generating a simulated spontaneous breathing in a simulated lung. An example system includes a first dedicated physical input element that controls a first simulation setting; a second dedicated physical input element that controls a second simulation setting; a motor; an actuator arm coupled to the motor, the actuator arm configured to be coupled to a portion of the simulated lung such that movement of the actuator arm causes the simulated lung to expand; and a housing including a processor and memory, the memory storing instructions that, when executed by the processor, cause activation of the motor to move the actuator arm according to the first simulation setting and the second simulation setting.

### CROSS-REFERENCE TO RELATED APPLICATIONS

This application claims the benefit of U.S. Provisional Application No. 63/346,492 filed May 27, 2022, entitled “Diaphragm Effort Simulator,” which is incorporated herein by reference in its entirety.

### INTRODUCTION

Modern medical ventilators are complex systems that can support a variety of patient respiratory conditions. Ventilator functionality is typically demonstrated and evaluated using a simulated lung system. The design of these simulated lungs can range from simple to complex. For example, lung functionality can be simulated using a basic inflatable assembly that mimics realistic lung compliance and resistance. Although these types of designs can emulate passive lung behavior, they lack the ability to replicate the active, spontaneous breathing efforts exhibited in real patients. It is with respect to this general technical domain that the present disclosure is directed.

It is with respect to this general technical environment that aspects of the present technology disclosed herein have been contemplated. Furthermore, although a general environment is discussed, it should be understood that the examples described herein should not be limited to the general environment identified herein.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

This disclosure describes systems and methods for a diaphragm effort simulator. The diaphragm effort simulator adds functionality to passive simulated lung systems, and allows those simulated lung systems to provide greater test capabilities for evaluating medical ventilators. The external assembly provides a lightweight and portable solution which allows clinical and engineering professionals to add active breathing effort simulations to passive lung systems.

In an aspect, the technology relates to a system for generating a simulated spontaneous breathing in a simulated lung. The system includes a first dedicated physical input element that controls a first simulation setting; a second dedicated physical input element that controls a second simulation setting; a motor; an actuator arm coupled to the motor, the actuator arm configured to be coupled to a portion of the simulated lung such that movement of the actuator arm causes the simulated lung to expand; and a housing including a processor and memory, the memory storing instructions that, when executed by the processor, cause activation of the motor to move the actuator arm according to the first simulation setting and the second simulation setting.

In an example, the first dedicated physical input is a first potentiometer and the second physical input is a second potentiometer. In another example, the first simulation setting is a size-of-effort setting and the second simulation setting is a speed-of-effort setting. In yet another example, the system further includes a third dedicated physical input element for setting a third simulation setting; and a fourth dedicated physical input element for setting a fourth simulation setting. In a further example, the third simulation setting is an offset setting and the fourth simulation setting is a frequency-of-effort setting. In still another example, the actuator arm moves from an offset position to peak effort position to simulate a breathing effort. In still yet another example, the first dedicated physical input and second dedicated physical input protrude from the housing.

In another aspect, the technology relates to a system for generating a simulated spontaneous breathing in a simulated lung. The system includes a motor; an actuator arm coupled to the motor, the actuator arm configured to be coupled to a portion of the simulated lung such that movement of the actuator arm causes the simulated lung to expand; a plurality of adapters, each adapter configured to couple to at least one of the actuator arm or the motor, the plurality of adapters including a first adapter for use with a first simulated lung type and a second adapter configured for use with a second simulated lung type; a first physical input element and a second physical input element; and a housing including a processor and memory, the memory storing instructions that, when executed by the processor, cause activation of the motor to move the actuator arm according to one or more simulation settings set by at least one of the first physical input element or the second physical input element.

In an example, the system further includes a bracket to which the motor and the simulated lung are attached. In another example, the motor is a servo motor. In still another example, the system further includes a first dedicated physical input element for adjusting a first simulation setting; and a second dedicated physical input element for adjusting a second simulation setting. In a further example, the first simulation setting is a size-of-effort setting and the second simulation setting is a speed-of-effort setting. In another example, the first simulation setting is an offset setting and the second simulation setting is a frequency-of-effort setting. In yet another example, the system further includes a third dedicated physical input for setting a third simulation setting; and a fourth dedicated physical input for setting a fourth simulation setting.

In another aspect, the technology relates to a method for adaptively simulating spontaneous breathing in a simulated lung. The method includes receiving one or more inputs that define simulation settings; receiving a selection of a type of simulated lung from a plurality of different types of simulated lungs; and activating a motor, according to the defined one or more simulation settings and the selected type of simulated lung, to move an actuator arm coupled to the simulated lung to cause the simulated lung to expand.

In an example, the simulation settings include at least two of an offset setting, a size-of-effort setting, a speed-of-effort setting, and a frequency-of-effort setting. In another example, the speed-of-effort setting controls a rate of movement of the actuator arm. In still another example, the frequency-of-effort setting the controls a frequency of movement of the actuator arm. In yet another example, activating the motor includes generating, based on the selected type of simulated lung and the simulation settings, a motor control signal, the motor control signal configured to cause the motor to move the actuator arm. In still another example, the inputs are received via two or more dedicated physical input elements.

### BRIEF DESCRIPTION OF THE DRAWINGS

The following drawing figures, which form a part of this application, are illustrative of aspects of systems and methods described below and are not meant to limit the scope of the disclosure in any manner, which scope shall be based on the claims.

FIG. 1 depicts a block diagram of a diaphragm effort simulator coupled to a simulated lung system.

FIG. 2 depicts an example diaphragm effort simulator.

FIG. 3A depicts an example system with a configuration of an actuator arm of a diaphragm effort simulator and a simulated lung.

FIG. 3B depicts another example system with a configuration of an actuator arm of a diaphragm effort simulator and a simulated lung.

FIG. 3C depicts another example system with a configuration of an actuator arm of a diaphragm effort simulator and a simulated lung.

FIG. 4 depicts another example system with a configuration of an actuator arm of a diaphragm effort simulator and a simulated lung.

FIG. 5 depicts another example system with a configuration of an actuator arm of a diaphragm effort simulator and a simulated lung.

FIG. 6 depicts an example method for simulating a diaphragm effort.

### DETAILED DESCRIPTION

Simulated lung systems (often referred to as “test lungs”) are commonly used to demonstrate and evaluate the functionality of medical ventilators. Modern ventilators are equipped with a variety of sensors and have a number of settings and operating modes that allow them to support a wide range of patient respiratory conditions. For example, certain models of ventilators have a mode that allows the ventilator to detect inhalation efforts of a patient during a breathing cycle. The ventilator may respond to this effort by supplying breathing gasses to the patient to assist the attempted breath. A simulated lung that can mimic this inhalation effort may be an important tool for evaluating and demonstrating such effort-based triggers for providing ventilation to the patient.

Not only are simulated lungs useful for testing ventilator functionality, simulated lungs may also be helpful in educating clinical staff and other medical professionals on ventilator capabilities. As mentioned in the example above, contemporary ventilators can support a number of sophisticated breathing modes, with additional features being developed and released on a regular basis. Experts in ventilator technology or other representatives often travel to clinical settings to demonstrate these ventilator features and teach the clinical staff how to use the ventilator features. Simulated lungs provide a means for the representatives to perform the demonstration, which allows for comparing and contrasting different ventilator models and breathing modes. Clinicians then have a better understanding of how the ventilator operates and how to configure the ventilator for a given patient condition.

The design of these simulated lungs themselves can range in complexity. A basic, passive lung consists of an expandable bladder or chamber for receiving a mixture of air and oxygen from the ventilator. The bladder may be implemented as a bellows, or may be a “bag-style” apparatus, both of which are commonly known in the art. These types of simulated lungs are designed with mechanical constraints that attempt to simulate common levels of compliance and airway resistance found in the human respiratory system. They are also available in an array of sizes that model different age ranges, from neonate up to adult. Some of these passive simulated lungs are relatively lightweight and portable, which allows them to be easily hand-carried into clinical settings. However, there is no active mechanism for simulating spontaneous breathing efforts, which is necessary for evaluating certain ventilator functions and for demonstrating advanced ventilator features to clinicians.

Other types of simulated lung systems are capable of delivering greater test functionality. For example, the more complex, active simulated lungs incorporate expandable bladders with mechanical constraints similar to those of the passive lungs. But these more complex systems may also incorporate electronic control that provides movement patterns to simulate the active inhalation or exhalation efforts exhibited in real patients. Despite the advanced capabilities of these active simulated lungs, there are several major drawbacks. For example, many of these systems are bulky and are quite heavy. As a result, those systems cannot be reasonably hand-carried into clinical environments or easily transported, such as on airplanes or other modes of transportation. In addition, these types of simulated lungs can be more complicated to operate, with the most advanced systems requiring an external computer and software package in order to configure operation. Because of the advanced feature sets available in these types of simulated lungs, they can be also be cost-prohibitive.

Considering the above tradeoffs between the more sophisticated, active simulated lung systems and the more basic, passive designs, a gap exists in the current art. To more effectively evaluate and demonstrate ventilator functionality, device manufacturers need specific capabilities and feature sets that are not available in any combination of existing solutions. For instance, other simulated lung systems are not portable and active elements of the system are permanently tied to a single passive test lung, which significantly limits the use of such systems.

The present technology addresses, among other things, the described limitations in existing simulated lungs. For instance, the present technology provides for a diaphragm effort simulator that may be coupled to a variety of passive simulated lung systems. The diaphragm effort simulator is able to simulate diaphragm movements of a patient when the patient makes a breathing effort. When coupled to the passive lung systems (e.g., a passive test lung), the passive test lung is transformed into an active lung simulation system. As such, in some examples, the diaphragm effort simulator serves as almost a universal adaptor to convert passive test lungs into active test lungs that can simulate patient breathing efforts. The diaphragm effort simulator may include a small motor connected to a rigid actuator arm, which engages the expandable bladder of a pre-existing simulated lung. The actuator arm imparts active motion that mimics or simulates patient inhalation efforts by at least partially expanding the bladder. The actuator arm may be coupled to a wide variety of commercially available simulated lungs via mechanical adapters. Because of this adaptability, the diaphragm effort simulator may be able to interface with a large range of human lung models, from neonate to adult.

The diaphragm effort simulator also includes an electronic control system, which is electrically coupled to the motor to allow for control of the motor. The control system may include a set of dedicated user input elements that allow the user to control a plurality of simulation settings. These simulation settings relate the movement of the actuator arm to the physiologic variables associated with breathing motions. Examples of physiologic variables may include, but are not limited to: positive end-expiratory pressure (PEEP), amplitude of inhalation effort, speed of inhalation effort, and respiratory rate. The speed of inhalation effort may be associated with a P0.1 value, which is the negative pressure measured 100 ms after the initiation of an inspiratory effort performed against a closed respiratory circuit and has been shown to be correlated with central respiratory drive and respiratory effort. Input signals from the user input elements are translated into output motor control signals that define the motion of the actuator arm, which imparts motion to expand the simulated lung. In turn, these expansion motions simulate the inhalation effort of a patient receiving ventilator support. The settings of the diaphragm effort simulator also may allow for real time changes as the diaphragm effort is being simulated (e.g., on-the-fly changes). For example, a turn of a knob may cause an instant change in the response of the system for the corresponding setting. Each setting may be adjusted irrespective of the other settings, which also provides for added configurability and usability of the system. For instance, in some examples, one setting may be changed without reference or changes to the other settings.

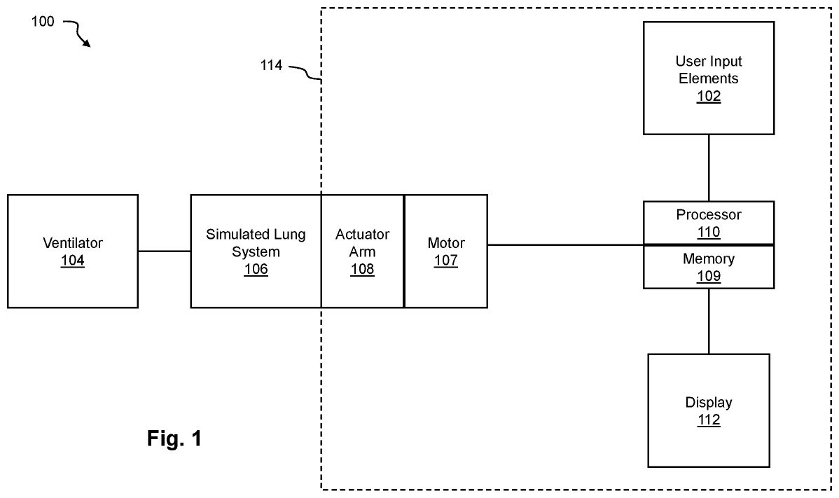

FIG. 1 depicts an example system 100. The system 100 includes a diaphragm effort simulator 114 connected to a passive simulated lung 106, which is in turn connected to a ventilator 104. The ventilator 104 may be connected to the simulated lung system 106 via tubing (e.g., a patient circuit) such that the ventilator 104 is able to deliver breathing gases to the simulated lung 106.

The diaphragm effort simulator 114 may include a set of dedicated user input elements 102, a processor 110, memory 109 that is in communication with the processor 110, a display 112, a motor 107, and an actuator arm 108. The set of dedicated user input elements 102 may each correspond to a different simulation setting of the diaphragm effort simulator 114. For example, the set of dedicated user input elements 102 may include physical input elements, such as a plurality of knobs, buttons, switches, etc. that allow for defining or adjusting different simulation settings of the diaphragm effort simulator 114. The different simulation settings may include an offset setting (corresponding to PEEP), a size of effort setting (corresponding to an amplitude of inhalation effort), a speed of effort (corresponding to how quickly a corresponding patient may inhale), and frequency of effort (corresponding to respiratory rate), among other potential settings. Each of the set of user input elements 102 may correspond to a different setting.

The programmed or set simulation settings may be communicated to the processor 110 and/or stored in the memory 109. In some examples, the user input elements 102 include a plurality of variable resistors (e.g., potentiometers) such that movement of a particular input element 102 changes the corresponding resistance value of that element. In such examples, the processor 110 may read or determine the current resistance value of the corresponding input element 102 to determine a particular simulation setting. In other examples, the simulation settings are stored in the memory 109 and accessed by the processor 110.

The determined or accessed simulation settings then control the motion of the motor 107 and actuator arm 108 via motor commands or signals issued from a processor 110. Movement of the motor 107 and actuator arm 108 imparts movement of the simulated lung 106. The movement of the simulated lung, such as expansion of the bladder, mimics or simulates a patient inhalation effort according to the simulation settings, which in turn correspond to different physiological conditions of a simulated patient. The simulated breathing effort may then be detected by the ventilator 104 and, if the simulated breathing effort meets a triggering condition of the ventilator mode, the ventilator 104 delivers a breath to the simulated lung 106. The delivered breath causes gases to flow into the simulated lung 106, which causes the simulated lung 106 to further expand.

The current simulation settings of the diaphragm effort simulator 114 may also be displayed on the display 112. For instance, each simulation setting may be displayed concurrently on the display 112. In other examples, the simulation settings may be displayed sequentially, which allows for the display to be smaller as less information needs to be displayed at any point in time.

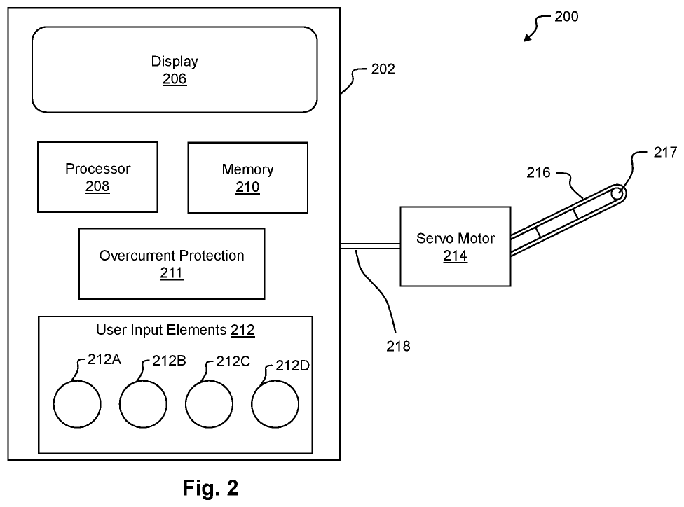

FIG. 2 depicts an example diaphragm effort simulator 200. In this example, a servo motor 214 provides a means of rotational motion for the actuator arm 216. The display 206, processor 208, memory 210, overcurrent protection circuitry 211, and user input elements 212 are collocated within a single housing 202. A cable 218 connects the servo motor 214 to the housing 202. The cable 218 provides power and control input to the servo motor 214. That cable may also provide a means for feedback control data or other data to be transferred between the servo motor 214 and housing 202. In other examples, the servo motor 214 may be separately powered, and the motor control signals from the processor 208 may be communicated wirelessly to the servo motor 214. In such examples of wireless communication or in the case of a longer cable 218, the servo motor 214 may be located remotely from the housing 202 such that the housing may be handheld while the servo motor 214 and the actuator arm 216 are coupled to the simulated lung. In some examples, to allow for the housing to be portable and/or handheld, the housing may have a total volume of less than 50 cubic inches and a total weight (including the components within the housing) of less than 2 or 3 pounds.

The actuator arm 216 protrudes from the servo motor 214 and is coupled to the servo motor 214 such that motion of the servo motor 214 causes movement of the actuator arm 216. The actuator arm 216 may be affixed to the rotational axle of the servo motor 214 using any known method. The actuator arm 216 may be of any construction that is sufficiently lightweight, yet rigid enough to adequately transmit the rotational force of the servo motor 214 to the simulated lung (not depicted in FIG. 2). In addition, the length of the actuator arm 216 may be selected or configured so that the arm can sufficiently interact with the simulated lung being connected. For instance, the dimensions of the actuator arm 216 may be configured based on a particular type or types of simulated lungs.

In some examples, the actuator arm 216 may be adjustable or replaceable to allow for connection to different types of simulated lungs. The length and/or width of the actuator arm 216 may be adjustable. Alternatively or additionally, the diaphragm effort simulator 200 may be provided with a plurality of different actuator arms 216 that may be coupled to the servo motor 214. Each actuator arm 216 may be configured for a different type of simulated lung. In yet other examples, adapters may be provided with the diaphragm effort simulator 200 to allow for the actuator arm to be effectively coupled to the simulated lung. For instance, each adapter may be an extension of a different length and/or width that connects to the actuator arm 216 to extend or expand the actuator arm 216 to allow for coupling to different types of simulated lungs. The adapters may connect to the actuator arm 216 via a through hole 217 in the actuator arm 216. Other connection mechanisms and systems are also possible.

Although a servo motor 214 is depicted in FIG. 2, other types of motors, such as direct-current (DC) motors or stepper motors, may be used in other examples. Embodiments that use other types of motors may require additional circuitry and/or digital processing in order to translate user input to appropriate motor control signals. The use of a servo motor 214 over other types of motors may be beneficial as the servo motor 214 provides for a compact motor that still provides high torque capabilities that are sufficient to expand multiple different types of simulated lungs.

The overcurrent protection 211 provides additional protection for the components of the diaphragm effort simulator 200, such as the servo motor 214. The overcurrent protection circuitry 211 monitors the current being drawn by the servo motor 214. Such monitoring may be provided by monitoring a current being provided to the server motor 214 or current being drawn by the servo motor 214 based on feedback received via the cable 218. Overcurrent situations may occur where the actuator arm 217 or a portion of the simulated lung is blocked and the servo motor 214 attempts to draw a higher amount of current to overcome the blockage or restriction to motion. For example, if a command is sent to the servo motor 214 to move the actuator arm 216 to a particular position, the servo motor 214 will draw current to reach that position. If the actuator arm 216 cannot reach the position (e.g., due to a blockage), additional current is drawn by the servo motor 214, which may cause overheating or damage to the servo motor 214. In some examples, the overcurrent protection circuitry is provided on a separate printed circuit board (PCB) from a PCB to which the memory 210 and processor 208 are physically connected.

An overcurrent event may be detected based on monitoring the current being drawn by the servo motor 214. When the amount of current being drawn is greater than a current threshold, an overcurrent event is detected or determined to have occurred. Upon an overcurrent event, a command is issued to the servo motor 214 to stop the attempt to continue moving the actuator. In some examples, based on the detection of the overcurrent event, a command is issued to the servo motor 214 to cause the servo motor 214 to move the actuator arm back to its lowest position or a lower position than the current position. The monitored current, voltage, and/or power drawn by the servo motor 214 may also be displayed on the display 206.

The user input elements 212 provide physical elements for the user to specify the simulation setting values that define the motion of the actuator arm 216. As described above, these parameters relate to the desired physiologic behavior to be simulated by the diaphragm effort simulator 200 when coupled to the simulated lung. The user input elements 212 may include a dedicated control for each of the simulation settings. The number of input user elements 212 may depend on the type of simulated lung being interfaced and/or the desired behavior of the actuator arm 216 for a particular example.

In the example depicted in FIG. 2, four user input elements 212 are included in the diaphragm effort simulator 200. More specifically, the user input elements 212 include a first user input element 212A, a second user input element 212B, a third user input element 212C, and a fourth user input element 212D. Each of the user input elements 212A-D may correspond to a different simulation setting. The user input elements 212A-D may also be physical input elements (e.g., knobs) that protrude from the housing such that a user is able to interact with (e.g., rotate) the input elements to change the corresponding simulation settings.

For instance, the first user input element 212A may be for controlling an offset setting. The offset setting may correspond to a PEEP value that would be provided by the ventilator to the patient. The offset setting controls a minimum return position of the actuator arm 216. For instance, to simulate a PEEP setting or condition, the actuator arm 216 may hold a simulated lung in a slightly expanded state even during an exhalation phase of a breath delivered by the ventilator. Accordingly, a higher offset setting causes the actuator arm to hold the simulated lung in a more expanded state during the exhalation phase.

The second user input element 212B may be for controlling a size-of-effort setting. The size-of-effort setting may correspond to an amplitude of a patient inhalation effort that is to be simulated. The size-of-effort setting controls how far the actuator arm 216 rotates when a breathing effort is initiated. For instance, a large size-of-effort setting causes the actuator arm 216 to rotate further to cause a greater expansion of the simulated lung, which simulates a larger breathing effort. In contrast, a small size-of-effort setting causes the actuator arm 216 to rotate a smaller amount to cause a smaller expansion of the simulated lung, which simulates a weaker breathing effort.

The third user input element 212C may be for controlling a speed-of-effort setting. The speed-of-effort setting may be correlated with a P0.1 value for a simulated patient and/or may correspond to how quickly a patient is attempting to inhale. The speed-of-effort setting controls how quickly the actuator arm 216 rotates or moves when a breathing effort is initiated. For example, a larger speed-of-effort setting causes the actuator arm 216 to move more rapidly when the breathing effort is initiated.

The fourth user input element 212D may be for controlling a frequency-of-effort setting. The frequency-of-effort setting may correspond to respiratory rate (e.g., number of breaths per minute). The frequency-of-effort setting controls how frequently a breathing effort is initiated. For instance, a higher frequency-of-effort setting causes a simulated breathing effort to be initiated more frequently. As discussed above, when a breathing effort is initiated, the actuator arm 216 moves to a peak position based on the size-of-effort setting, and the time it takes the actuator arm 216 to move to that position is based on the speed-of-effort setting. Once the actuator arm 216 reaches the peak position, the actuator arm 216 then returns back to an offset position based on the offset setting.

These simulation settings may also be changed during operation of the diaphragm effort simulator. For instance, a clinician may desire to have the actuator arm 314 motion match a particular respiratory condition. By manipulating the user input elements 212, the clinician is able to continually adjust the behavior of the diaphragm effort simulator to simulate the particular respiratory condition.

The processor 208 and memory 210 are depicted in FIG. 2 as separate elements within the housing 202. However, the memory 210 may also be embodied as internal memory within the processor 208. For instance, the processor 208 and memory 210 may be part of a mini-computer or other similar device, such as an ARDUINO-based mini-computer or circuit board. The function of the memory 210 is to store any executable code necessary for the operation of the processor 208 and/or control of the servo motor 214 and to store any type of data the user may wish to save. Examples of stored data can include configuration settings, user-specified parameters or simulation settings, or general-purpose data. Other examples of the present technology may include a memory element that is not accessible to the user. In such an example, the memory 210 may function to store only any executable code necessary for the operation of the processor 208 or control of the servo motor 214.

In some examples of the present technology, the function of the processor 208 may be carried out by alternative forms of control circuitry. For example, a combination of analog and/or digital logic circuitry may be used to convert input signals from the user input elements 212 into output control signals for the servo motor 214 to provide control of actuator arm 216 movement. Such circuitry may be referred to as processing circuitry, and the term processing circuitry is also intended to include one or more processors.

The display 206 provides a visual indication of user-specified simulation setting values, device status, and/or data to the user. The display 206 can be chosen from a variety of embodiments that are commonly known in the art. Examples include LCDs, OLEDs, and other graphical display technologies. More basic displays can include LEDs, seven-segment displays, or the like.

Power may be provided by connection to wall socket or some other external power source, and a transformer or other step-down power conversion circuitry may be provided to lower the voltage a level suitable for the circuitry of the diaphragm effort simulator 200. In other examples, one or more batteries may be included in the housing 202. The batteries may also be rechargeable via a charging port on the housing 202. The use of batteries provides additional portability features for the diaphragm effort simulator.

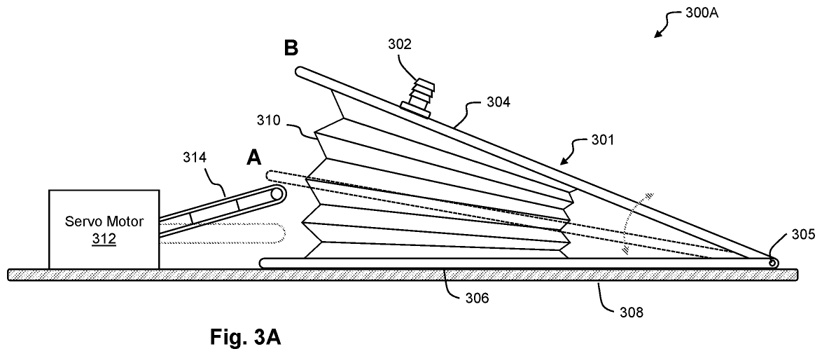

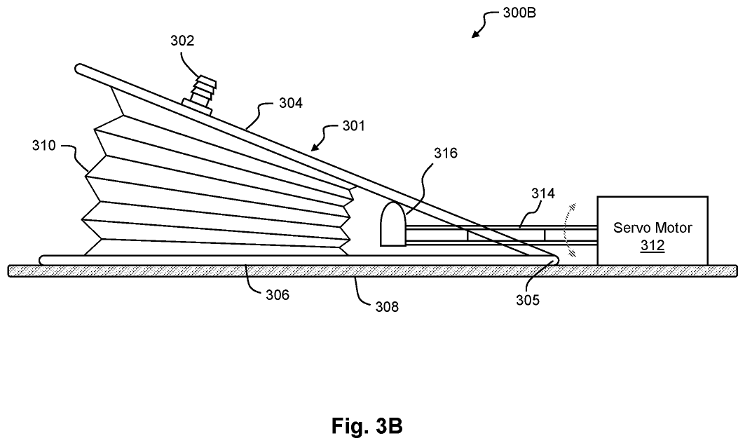

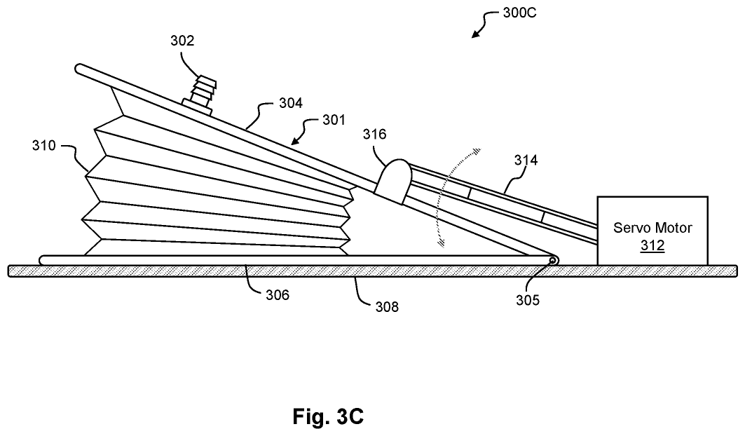

FIG. 3A depicts an example system 300A with a configuration of an actuator arm 314 of a diaphragm effort simulator and a simulated or test lung 301. In this example, the test lung 301 includes an expandable bellows 310 that acts as an expandable bladder or chamber to receive and expel gases. The bellows 310 is connected to a top plate 304 and a bottom plate 306. These two plates are joined at a common hinge 305, such that the free ends of the plates can rotate away from one another as the bellow 310 expands. A tubing connection port 302 is used to connect the simulated lung to a ventilator by way of tubing (not depicted) from the ventilator to the port 302.

The bellows 310 expand when gas is received from the ventilator, such as when a breath is delivered by the ventilator. The bellows 310 contract when gas is expelled from the bellows 310, such as during an exhalation phase of a breath. Expansion or contraction of the bellows 310 may also be controlled by mechanically manipulating the top plate 304 and/or the bottom plate 306. For instance, the top plate 304 may be mechanically manipulated by the actuator arm 314 to simulated a breathing effort.

In the example depicted, for the actuator arm 314 to interact with the simulated lung 301, the bottom plate 306 may be mounted to a larger surface, plate, or bracket 308. The servo motor 312 is also mounted to the bracket 308 to provide a common surface for the servo motor 312 and the simulated lung 301. The surface or bracket 308 provides a counteracting surface for the force of the servo motor 312 to affect the movement of the top plate 304 of the simulated lung. In some examples, the simulated lung 301 itself may provide a sufficient surface for the servo motor 312 to be rigidly mounted and the bracket 308 may be omitted. Examples can include housing or chassis elements of the simulated lung 301 or rigid plates connected to the simulated lung 301. In such an example, an appropriate mounting connector may be provided that affixes the servo motor 312 to such a surface. Similar to the adapters for the actuator arm 314 discussed above, multiple mounting connectors may be provided with the diaphragm effort simulator to allow for connection of the servo motor 312 to different types of the test lungs 301. In addition or alternatively, multiple different brackets 308 may be provided with the diaphragm effort simulator to allow for connection to different types of test lungs 301.

The servo motor 312 is positioned such that the actuator arm 314 intercepts and contacts the top plate 304 within the lower end of the range of travel of the top plate 304. In the present example, the actuator arm 314 contacts the top plate 304, but the actuator arm 314 is not connected to the top plate 304. Accordingly, the top plate 304 may move freely away from the actuator arm 314 in the upward (e.g., expansion) direction.

At initialization of the system and/or during an exhalation phase of a breath delivered by the ventilator, the test lung 301 is in a contracted or collapsed position, which is illustrated as the top plate 304 being Position A. When the test lung 301 is in Position A, the top plate 304 of the test lung 301 is in contact with the actuator arm 314. The position of the actuator arm 314 during the exhalation phase is based on the offset setting, as discussed above. As an example, the actuator arm 314 may hold the top plate 304 in Position A to simulate a PEEP setting or condition. For instance, without the actuator arm 314 supporting the top plate 304 in Position A, test lung 301 would further contract or collapse.

When a breathing effort is initiated by the diaphragm effort simulator according to the frequency of effort setting, actuator arm 314 begins to rotate in an upward direction (e.g., away from the bottom plate 306). The movement of the actuator arm 314 pushes the top plate 304 upward, which in turn causes the bellows 310 to expand. The amount that the actuator arm 314 moves upward is based on the size-of-effort setting and the speed at which the actuator arm 314 moves is based on the speed-of-effort setting.

The upward movement of the top plate 304 and the expansion of the bellows 310 simulates or mimics a breathing effort by a patient. As the bellows 310 expands, the change in pressure due to the increased volume of the bellows 310 causes gas to be drawn into the bellows 310 via the port 302. The change in pressure and/or the flow of gas into the bellows may be detected by the ventilator. Such pressure and/or flow changes may be detected by the ventilator using pressure and/or flow sensors disposed within the ventilator and/or coupled to the tubing between the ventilator and the port 302. Depending on the ventilator mode and ventilator settings of the ventilator, such changes in pressure and/or flow may trigger a breath to be delivered by the ventilator to the test lung 301 if the triggering conditions of the ventilator are met. One example of a trigger is a signal distortion trigger discussed in U.S. patent application Ser. No. 16/411,916, titled “Systems and Methods for Respiratory Effort Detection Utilizing Signal Distortion” (hereinafter “the '916 Application”), which is incorporated herein in its entirety. The present diaphragm effort simulator may be configured to simulate the types of distortions and breathing efforts discussed in the '916 Application.

When the triggering conditions of the ventilator are met, the ventilator delivers a breath (e.g., supplies gas) to the test lung 301. As the ventilator supplies gas to the test lung 301, the bellows 310 expands, causing the free ends of the top plate 304 and bottom plate 306 to rotate or move away from each other. When the ventilator delivers the full breath volume (e.g., tidal volume), the bellows 310 is at maximum inflation and the top plate 304 reaches Position B. The ventilator then transitions to the exhalation phase of the assisted breath, which allows the mechanical constraints of the simulated lung to pull the top plate 304 towards the bottom plate 306, expelling air from the bellow 310. Ultimately, the top plate 304 returns to Position A (e.g., the offset or PEEP set point) where the top plate 304 intercepts or contacts the actuator arm 314. After a duration of time according to the frequency of effort setting, the actuator arm 314 then again rotates upward to simulate another breathing effort.

FIG. 3B depicts another example system 300B with another configuration of an actuator arm 314 of a diaphragm effort simulator and a simulated lung 301. Similar to the example above, the simulated lung 301 and servo motor 312 are mounted to a common bracket 308. In this example, the servo motor 312 is located in such a position that the actuator arm 314 engages the top plate 304 closer to the hinge 305 of the simulated lung 301. The servo motor 312 may be positioned on any side of the simulated lung 301 such that the adapter arm 314 is able to contact the top plate 304 and cause the expansion of the bellows 310 that simulates the breathing efforts discussed herein.

This configuration illustrates one of many possible arrangements where the servo motor 312 and actuator arm 314 are positioned to interact with the simulated lung. In this example, the actuator arm 314 is fitted with an arm adapter 316 to provide mechanical engagement between the actuator arm 316 and simulated lung 301. The arm adapter 316 may be one of many adapters that are available with the diaphragm effort simulator to provide different options for connecting the diaphragm effort simulator to different types of test lungs.

FIG. 3C depicts another example system 300C with a configuration of an actuator arm 314 of a diaphragm effort simulator and a simulated lung 301. In the example system 300C, instead of providing a pushing motion against the top plate 304, the actuator arm 314 provides a pulling motion on the top plate 304 to cause the expansion of the bellows 310. To achieve the pulling motion, the adapter 316 and/or the actuator arm 314 may be connected to the top plate 304 such that upward movement of the actuator arm 314 pulls the top plate 304 upward and away from the bottom plate 306.

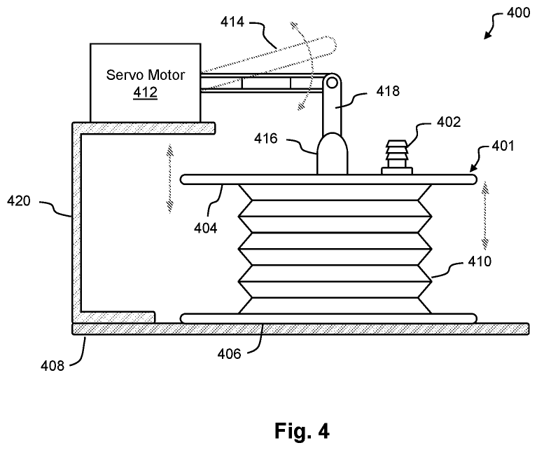

FIG. 4 depicts another example system 400 with a configuration of an actuator arm 414 of a diaphragm effort simulator and a simulated lung 401. The example system 400 differs from the examples above primarily in that the simulated lung 401 does not utilize hinged plates, but instead uses plates that are separated from one another and are designed for rectilinear motion. For example, the simulated lung 401 includes a top plate 404, a bottom plate 406, and a bellows 410 positioned between the top plate 404 and the bottom plate 406. The top plate 404 is substantially parallel to the bottom plate 406. As the top plate 404 moves away from the bottom plate 406, the bellows 410 expands similar to the examples described above. Gases may flow in and out of the bellows 410 via the port 402.

In the example depicted, the actuator arm 414 is connected to the top plate 404 via an arm adapter 416 and additional mechanical linkage 418. The mechanical linkage 418 assists in translating the rotational motion of the actuator arm 414 to the translational motion that matches the linear separation of the top plate 404 and the bottom plate 406. For example, the mechanical linkage 418 may be attached or coupled to the actuator arm 414 in a manner such that the mechanical linkage 418 can rotate about the actuator arm 414 at one end of the mechanical linkage 418. The other end of the mechanical linkage 418 is coupled to the arm adapter 416, which is configured to connect to the top plate 404 of the simulated lung 401.

When the actuator arm moves 414 upwards, the top plate 404 also moves upwards due to the pulling force of the arm adapter 416, which causes an expansion of the bellows 410 to simulate an inhalation breathing effort. In some examples, the adapter 416 may be affixed to the top plate 404 such that the actuator arm 414 may also push the top plate 404 downward to simulate an exhalation effort.

A vertical bracket 420 and a horizontal bracket 408 may also be included with the diaphragm effort simulator to help position the servo motor 412 and the actuator arm 414 in a position to interface with the simulated lung 401. The vertical bracket 420 and the horizontal bracket 408 provide rigid interconnection between the servo motor 412 and the simulated lung 401 such that force exerted by the actuator arm 414 is imparted to the top plate 404. The diaphragm effort simulator may be provided with multiple combinations of vertical brackets and horizontal brackets to allow for connection to different types of simulated lungs. In some examples, the simulated lung 401 itself may provide a sufficient surface for the servo motor 412 to be rigidly mounted. Examples can include housing or chassis elements of the simulated lung, or rigid plates connected to the simulated lung 401. In these cases, an appropriate mounting connector that affixes the servo motor 412 to such a surface may be implemented.

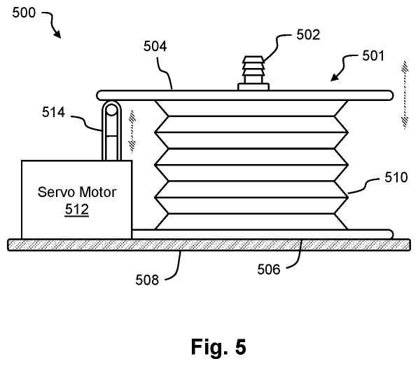

FIG. 5 depicts another example system 500 with a configuration of an actuator arm 514 of a diaphragm effort simulator and a simulated lung 501. The example system 500 is similar to the system 400 in FIG. 4 in that the simulated lung 501 is configured for linear expansion and contraction. In contrast to the system 400, the system 500 utilizes a servo motor 512 and an actuator arm 414 that produces linear, translational motion of the actuator arm 514 rather than rotational movement in the examples discussed above. The translational movement may be achieved through gears, rack-and-pinion components, or other mechanisms that transform the rotational motion of the servo motor 512 into linear motion of the actuator arm 514. In the example depicted, the simulated lung 501 and the servo motor 512 may be attached to common bracket 508.

Similar to previously described examples, the actuator arm 514 intercepts the top plate 504 of the simulated lung 501 as the bellows 510 deflates during the exhalation cycle. The servo motor 512 imparts force through the actuator arm 514 to cause upward movement of the top plate 504 (e.g., away from the bottom plate 506) and an expansion of the bellows 510. This expansion causes gas to be drawn into the bellows 510, through the port 502, which simulates an inhalation effort, as discussed above. While the translational configuration of the servo motor 512 and the actuator arm 514 is shown in FIG. 5 as being used with the linear configuration of the simulated lung 501, such a translational configuration of servo motor 512 and the actuator arm 514 may be used with a hinged simulated lung or other configurations of a simulated lung.

Other examples of the actuator arms and configurations are also contemplated. For instance, a scissor-based actuator arm that expands and contracts with movement of the servo motor may be implemented. Such a configuration may be useful for a bag or bladder based simulated lung that does not include rigid top or bottom plates.

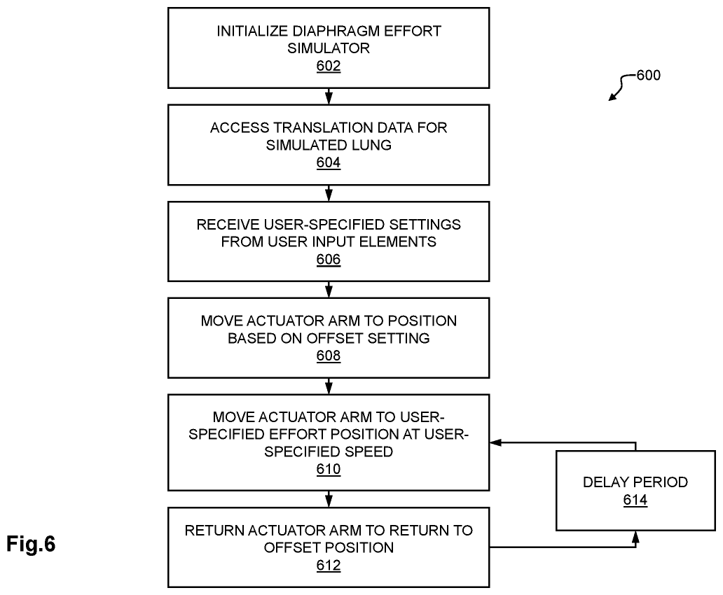

FIG. 6 depicts an example method 600 for simulating a diaphragm effort. The operations of method 600 may be performed by the diaphragm effort simulator or the components thereof, such as the processing circuitry of the diaphragm effort simulator.

At operation 602, the diaphragm effort simulator is initialized. The initialization may include calibrating the diaphragm effort simulator and/or receiving inputs from the user, such as changes to simulation settings via the user input elements. In some examples, initialization may also include an input of the type of simulated lung to which the diaphragm effort simulator attached. For instance, the diaphragm effort simulator may display a list of simulated lung types for selection by a user. The initialization may occur after the servo motor has been positioned relative to the simulated lung such that the adapter arm can contact and interface with the portion of the simulated lung that causes the lung to expand, such as the top plate of the simulated lung. Placing or positioning the servo motor may also include attaching or connecting the appropriate brackets, adapters, and/or mechanical linkages for the particular type of simulated lung.

At operation 604, translation data for the selected simulated lung type at initialization is accessed from memory of the diaphragm effort simulator. To translate the simulation settings into appropriate motor commands for the motor of the diaphragm effort simulator, translation data for the particular type of simulated lung may need to be used. For example, a size of effort setting may produce different results for one simulated lung type versus another simulated lung type. The translation data for each simulated lung type may help provide a more consistent result from a common simulation setting across the different simulated lungs.

In some examples, there are no inputs received for a particular type of simulated lung. Rather, the diaphragm effort simulator operates on default translation data that produces the same type of movement of the actuator arm, according to the simulation settings, for all types of simulated lungs.

At operation 606, user-specified simulation settings are received. The simulation settings may be received via the user input elements of the diaphragm effort simulator. For instance, a user may rotate or manipulate one or more of the user input elements to change the simulation settings, such as the offset setting, the size-of-effort setting, the speed-of-effort setting, and/or the frequency-of-effort setting. Operation 606 may also include displaying the received simulation settings.

At operation 608, the actuator arm is moved to a position corresponding to the offset setting. Moving the actuator arm may include translational or rotational motion of the actuator arm. The movement of the actuator arm may be achieved by generating a motor control signal that is sent to the motor to cause the motor to move the actuator arm to the offset position. The motor control signal may be based on the translation data accessed in operation 604 along with the offset setting.

At operation 610, a breathing effort is simulated by the diaphragm effort simulator by moving the actuator arm to a peak effort position at a particular rate of speed. The peak effort position is based on the user-specified size-of-effort setting, and the rate of speed is based on the user-specified speed-of-effort setting. The movement of the actuator arm to the peak effort position may be achieved by generating a motor control signal that is sent to the motor to cause the motor to move the actuator arm to the peak effort position at the particular rate of speed. The motor control signal may be based on the translation data accessed in operation 604 along with the size-of-effort setting and the speed-of-effort setting.

As discussed above, the movement of the actuator arm to the peak effort position causes the simulated lung to expand, or more specifically, causes a bladder or chamber of the simulated lung to expand. The expansion of the simulated lung causes the simulated lung to draw in air, which may be detected by a ventilator. If the expansion of the simulated lung triggers a breath to be delivered, the simulated lung receives the corresponding gases, which causes the simulated lung to further expand. In examples, the expansion of the lung may cause the lung to no longer be in contact with the actuator arm and/or any adapter that may be attached to the actuator arm.

Subsequent to the actuator arm being moved to the peak effort position, the actuator arm returns to the offset position in operation 612. In some examples, the actuator arm returns to the offset position from the peak effort position at a rate of speed that is the same or different from the rate of speed at which the actuator arm moves from the offset position to the peak effort position. For example, the actuator arm may return to the offset position at a default rate of speed that does not change based on the speed-of-effort setting. In other examples, the rate at which the actuator arm returns to the offset position may be based on yet another simulation setting, which may be referred to as the offset return setting. Like the other simulation settings, the offset return setting may be user specified and/or may be adjusted through a user input element. The movement of the actuator arm back to the offset position may be achieved by generating a motor control signal that is sent to the motor to cause the motor to move the actuator arm back to the offset position.

At operation 614, a delay period occurs prior to the method 600 flowing back to operation 610 where another simulated breathing effort is initiated. The delay period is based on the frequency of effort setting, which corresponding to a simulated breathing rate. As an example, for a frequency of effort setting of 20 breaths per minute, the delay period is 3 seconds. After expiration of the delay period, the method 600 flows back to operation 610 where another breathing effort is simulated (e.g., the actuator arm is moved back to the peak effort position).

Those skilled in the art will recognize that the methods and systems of the present disclosure may be implemented in many manners and as such are not to be limited by the foregoing aspects and examples. In other words, functional elements being performed by a single or multiple components, in various combinations of hardware and software or firmware, and individual functions, can be distributed among software applications at either the client or server level or both. In this regard, any number of the features of the different aspects described herein may be combined into single or multiple aspects, and alternate aspects having fewer than or more than all of the features herein described are possible.

Functionality may also be, in whole or in part, distributed among multiple components, in manners now known or to become known. Thus, a myriad of software/hardware/firmware combinations are possible in achieving the functions, features, interfaces and preferences described herein. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Further, as used herein and in the claims, the phrase “at least one of element A, element B, or element C” is intended to convey any of: element A, element B, element C, elements A and B, elements A and C, elements B and C, and elements A, B, and C. In addition, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Numerous other changes may be made which will readily suggest themselves to those skilled in the art and which are encompassed in the spirit of the disclosure and as defined in the appended claims. While various aspects have been described for purposes of this disclosure, various changes and modifications may be made which are well within the scope of the disclosure. Numerous other changes may be made which will readily suggest themselves to those skilled in the art and which are encompassed in the spirit of the disclosure and as defined in the claims.

What is claimed is:

1. A system for generating a simulated spontaneous breathing in a simulated lung, the system comprising:
a first dedicated physical input element that controls a first simulation setting;
a second dedicated physical input element that controls a second simulation setting;
a motor;
an actuator arm coupled to the motor, the actuator arm configured to be coupled to a portion of the simulated lung such that movement of the actuator arm causes the simulated lung to expand; and
a housing including a processor and memory, the memory storing instructions that, when executed by the processor, cause activation of the motor to move the actuator arm according to the first simulation setting and the second simulation setting.

2. The system of claim 1, wherein the first dedicated physical input is a first potentiometer and the second physical input is a second potentiometer.

3. The system of claim 1, wherein the first simulation setting is a size-of-effort setting and the second simulation setting is a speed-of-effort setting.

4. The system of claim 1, further comprising:
a third dedicated physical input element for setting a third simulation setting; and
a fourth dedicated physical input element for setting a fourth simulation setting.

5. The system of claim 4, wherein third simulation setting is an offset setting and the fourth simulation setting is a frequency-of-effort setting.

6. The system of claim 1, wherein the actuator arm moves from an offset position to peak effort position to simulate a breathing effort.

7. The system of claim 1, wherein the first dedicated physical input and second dedicated physical input protrude from the housing.

8. A system for generating a simulated spontaneous breathing in a simulated lung, the system comprising:
a motor;
an actuator arm coupled to the motor, the actuator arm configured to be coupled to a portion of the simulated lung such that movement of the actuator arm causes the simulated lung to expand;
a plurality of adapters, each adapter configured to couple to at least one of the actuator arm or the motor, the plurality of adapters including a first adapter for use with a first simulated lung type and a second adapter configured for use with a second simulated lung type;
a first physical input element and a second physical input element; and
a housing including a processor and memory, the memory storing instructions that, when executed by the processor, cause activation of the motor to move the actuator arm according to one or more simulation settings set by at least one of the first physical input element or the second physical input element.

9. The system of claim 8, further comprising a bracket to which the motor and the simulated lung are attached.

10. The system of claim 8, wherein the motor is a servo motor.

11. The system of claim 8, further comprising:
a first dedicated physical input element for adjusting a first simulation setting; and
a second dedicated physical input element for adjusting a second simulation setting.

12. The system of claim 11, wherein the first simulation setting is a size-of-effort setting and the second simulation setting is a speed-of-effort setting.

13. The system of claim 11, wherein the first simulation setting is an offset setting and the second simulation setting is a frequency-of-effort setting.

14. The system of claim 11, further comprising:
a third dedicated physical input for setting a third simulation setting; and
a fourth dedicated physical input for setting a fourth simulation setting.

15. A method for adaptively simulating spontaneous breathing in a simulated lung, the method comprising:
receiving one or more inputs that define simulation settings;
receiving a selection of a type of simulated lung from a plurality of different types of simulated lungs; and
activating a motor, according to the defined one or more simulation settings and the selected type of simulated lung, to move an actuator arm coupled to the simulated lung to cause the simulated lung to expand.

16. The method of claim 15, wherein the simulation settings include at least two of an offset setting, a size-of-effort setting, a speed-of-effort setting, and a frequency-of-effort setting.

17. The method of claim 16, wherein the speed-of-effort setting controls a rate of movement of the actuator arm.

18. The method of claim 16, wherein the frequency-of-effort setting the controls a frequency of movement of the actuator arm.

19. The method of claim 15, wherein activating the motor includes generating, based on the selected type of simulated lung and the simulation settings, a motor control signal, the motor control signal configured to cause the motor to move the actuator arm.

20. The method of claim 15, wherein the inputs are received via two or more dedicated physical input elements.
